(19) United States
(12) Patent Application Publication
(10) Pub. No.: US 2024/0181712 A1
(43) Pub. Date: Jun. 6, 2024

(54) METHOD AND SYSTEM FOR MEASURING A JETTING CHARACTERISTIC

(71) Applicant: Stratasys Ltd., Rehovot (IL)

(72) Inventors: Omer SINWANI, Petach-Tikva (IL); Gai OTTOLENGHI, Rehovot (IL)

(73) Assignee: Stratasys Ltd., Rehovot (IL)

(21) Appl. No.: 18/283,230

(22) PCT Filed: Mar. 24, 2022
(86) PCT No.: PCT/IL2022/050325

§ 371 Date: Sep. 21, 2023

Related U.S. Application Data
(60) Provisional application No. 63/165,804, filed on Mar. 25, 2021.

(51) Int. Cl. B29C 64/393; B29C 64/112; B29C 64/209; B33Y 10/00; B33Y 30/00; B33Y 50/02

(52) U.S. Cl. CPC B29C 64/393; B29C 64/112; B29C 64/209; B33Y 10/00; B33Y 30/00; B33Y 50/02

(57) ABSTRACT

A printing system comprises an inkjet printing head having a plurality of nozzles, and a container containing a liquid material and being in fluid communication with the head by a conduit for feeding the head with the liquid material. The printing system also comprises a pressure sensor configured to generate a signal indicative of a pressure at an outlet of the conduit, and a controller configured to control the head to dispense through the nozzles liquid material received via the conduit, and to calculate one or more jetting characteristics based on the pressure.

### RELATED APPLICATION/S

This application claims the benefit of priority of U.S. Provisional Patent Application No. 63/165,804 filed on Mar. 25, 2021, the contents of which are incorporated herein by reference in their entirety.

### FIELD AND BACKGROUND OF THE INVENTION

The present invention, in some embodiments thereof, relates to printing and, more particularly, but not exclusively, to a method and system for measuring one or more jetting characteristics, such as, but not limited to, drop size and nozzle functionality.

Additive manufacturing (AM) is a technology enabling fabrication of shaped structures directly from computer data via additive formation steps. The basic operation of any AM system consists of slicing a three-dimensional computer model into thin cross sections, translating the result into two-dimensional position data and feeding the data to control equipment which fabricates a three-dimensional structure in a layerwise manner.

Additive manufacturing entails many different approaches to the method of fabrication, including three-dimensional (3D) printing such as 3D inkjet printing, electron beam melting, stereolithography, selective laser sintering, laminated object manufacturing, fused deposition modeling and others.

Some 3D printing processes, for example, 3D inkjet printing, are being performed by a layer by layer inkjet deposition of building materials. Thus, a building material is dispensed from a dispensing head having a set of nozzles to deposit layers on a supporting structure. Depending on the building material, the layers may then be cured or solidified using a suitable device.

Various three-dimensional printing techniques exist and are disclosed in, e.g., U.S. Pat. Nos. 6,259,979, 6,569,373, 6,658,314, 6,850,334, 6,863,859, 7,183,335, 7,209,797, 7,225,045, 7,300,619, 7,500,846, 9,031,680 and 9,227,365, U.S. Published Application No. 20060054039, and International publication No. WO2016/009426, all by the same Assignee, and being hereby incorporated by reference in their entirety.

### SUMMARY OF THE INVENTION

According to an aspect of some embodiments of the present invention there is provided a printing system. The system comprises: an inkjet printing head having a plurality of nozzles; a container, containing a liquid material and being in fluid communication with the head by a conduit for feeding the head with the liquid material; a pressure sensor configured to generate a signal indicative of a pressure at an outlet of the conduit; and a controller, configured to control the head to dispense through the nozzles liquid material received via the conduit, and to calculate at least one jetting characteristic based on the pressure.

According to some embodiments of the invention the controller is configured to receive computer print data from an external source, and to calculate the jetting characteristic(s) while forming printed patterns according to the computer print data.

According to some embodiments of the invention the controller is configured to execute a noise reduction procedure.

According to some embodiments of the invention the head is at a higher level than the container. According to some embodiments of the invention the head is at a lower level than the container, wherein the container feeds the head via a sub-tank having an opening to the atmosphere and being connected to the head by the conduit.

According to an aspect of some embodiments of the present invention there is provided a method of calculating a jetting characteristic of a printing system. The method comprises receiving from a pressure sensor a signal indicative of a pressure at an outlet of a conduit feeding a printing head with liquid material, and calculating at least one jetting characteristic based on said pressure.

According to some embodiments of the invention the method comprises receiving computer print data from an external source, and calculating the jetting characteristic(s) while forming printed patterns according to the computer print data.

According to some embodiments of the invention the method comprises executing a noise reduction procedure.

According to some embodiments of the invention the jetting characteristic(s) comprise an average drop mass dispensed from the head.

According to some embodiments of the invention the method comprises adjusting a voltage applied to the head based on the calculated average drop mass. According to some embodiments of the invention the controller is configured to adjust a voltage applied to the head based on the calculated average drop mass.

According to some embodiments of the invention the jetting characteristic(s) comprise a mass change per number of dispensing events from the nozzles.

According to some embodiments of the invention the jetting characteristic(s) comprise a number of operative nozzles in the head.

According to some embodiments of the invention the method comprises identifying among the plurality of nozzles a subset of nozzles in which at least one nozzle is defective, based on the number of operative nozzles. According to some embodiments of the invention the controller is configured to identify among the plurality of nozzles a subset of nozzles in which at least one nozzle is defective, based on the number of operative nozzles.

According to some embodiments of the invention the jetting characteristic(s) comprise a mass flow rate through the nozzles.

According to some embodiments of the invention the method comprises individually identifying a defective nozzle among the plurality of nozzles, based on the number of operative nozzles. According to some embodiments of the invention the controller is configured to individually identify a defective nozzle among the plurality of nozzles, based on the number of operative nozzles.

According to some embodiments of the invention the system is a two-dimensional printing system.

According to some embodiments of the invention the system is a three-dimensional printing system.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A-D are schematic illustrations of an additive manufacturing system according to some embodiments of the invention;

FIGS. 2A-2C are schematic illustrations of printing heads according to some embodiments of the present invention;

FIGS. 3A and 3B are schematic illustrations demonstrating coordinate transformations according to some embodiments of the present invention;

FIGS. 4A and 4B are schematic illustrations showing a printing system according to some embodiments of the present invention;

FIG. 5 shows a measured pressure as a function of a height from a printing head, as obtained in an experiment performed according to some embodiments of the present invention;

FIG. 6 shows a multiplication of a measured pressure by a cross-sectional area of a conduit as a function of a mass jetted from a printing head, as obtained in an experiment performed according to some embodiments of the present invention;

FIG. 7A shows a pressure measured by a pressure sensor as a function of the time, as obtained in an experiment performed according to some embodiments of the present invention;

FIG. 7B shows a zoom-in along the ordinate of FIG. 7A;

FIG. 8A shows a pressure measured by a pressure sensor (left ordinate) and a corresponding mass change per firing event (right ordinate), as a function of the time, as obtained in an experiment performed according to some embodiments of the present invention;

FIG. 8B shows pressure jumps during jetting (left ordinate) and a corresponding mass change per firing event (right ordinate) as a function of the number of operative nozzles (FIG. 8B), as obtained in an experiment performed according to some embodiments of the present invention;

FIG. 9A shows a pressure measured by a pressure sensor (left ordinate) and the corresponding drop mass (right ordinate), as a function of the time, as obtained in an experiment performed according to some embodiments of the present invention.

FIG. 9B show pressure jumps during jetting (left ordinate) and the corresponding drop mass (right ordinate), as a function of a voltage applied to the printing head, as obtained in an experiment performed according to some embodiments of the present invention.

FIGS. 10A and 10B show a difference between a pressure measured by a pressure sensor during jetting and a pressure measured by the pressure sensor without jetting (left ordinate), and the corresponding drop mass (right ordinate), as a function of the nozzle's index, as obtained in an experiment performed according to some embodiments of the present invention; and

FIG. 11 exemplifies measurement samplings over a graph of a pressure as a function of the time, according to some embodiments of the present invention.

### DESCRIPTION OF SPECIFIC EMBODIMENTS OF THE INVENTION

The present invention, in some embodiments thereof, relates to printing and, more particularly, but not exclusively, to a method and system for measuring one or more jetting characteristics, such as, but not limited to, drop size and nozzle functionality.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The method and system of the present embodiments is preferably used in inkjet printing. In some embodiments of the present invention the method and system is employed by a printing system prints that two-dimensional objects on a receiving substrate, and in some embodiments of the present invention the method and system is employed by a printing system that manufactures three-dimensional objects in a layerwise manner by forming a plurality of layers in a configured pattern corresponding to the shape of the objects. While the embodiments below are described with more emphasis on three-dimensional printing, it is to be understood that two-dimensional printing is also contemplated.

The printing is based on printing data. When three-dimensional printing is employed, the printing data include computer object data which can be in any known format, such as, but not limited to, a Standard Tessellation Language (STL) or a StereoLithography Contour (SLC) format, an OBJ File format (OBJ), a 3D Manufacturing Format (3MF), Virtual Reality Modeling Language (VRML), Additive Manufacturing File (AMF) format, Drawing Exchange Format (DXF), Polygon File Format (PLY) or any other format suitable for Computer-Aided Design (CAD).

The term “object” as used herein refers to a whole object (2D or 3D) or a part thereof.

Each layer can be formed by an AM apparatus which scans a two-dimensional surface and patterns it. While scanning, the apparatus visits a plurality of target locations on the two-dimensional layer or surface, and decides, for each target location or a group of target locations, whether or not the target location or group of target locations is to be occupied by building material formulation, and which type of building material formulation is to be delivered thereto. The decision is made according to a computer image of the surface.

In preferred embodiments of the present invention the AM comprises three-dimensional printing, more preferably three-dimensional inkjet printing. In these embodiments a building material is dispensed from a printing head having one or more arrays of nozzles to deposit building material in layers on a supporting structure. The AM apparatus thus dispenses building material in target locations which are to be occupied and leaves other target locations void. The apparatus typically includes a plurality of arrays of nozzles, each of which can be configured to dispense a different building material. This is typically achieved by providing the printing head with a plurality of fluid channels separated from each other, wherein each channel receives a different building material through a separate inlet and conveys it to a different array of nozzles.

Thus, different target locations can be occupied by different building material formulations. The types of building material formulations can be categorized into two major categories: modeling material formulation and support material formulation. The support material formulation serves as a supporting matrix or construction for supporting the object or object parts during the fabrication process and/or other purposes, e.g., providing hollow or porous objects. Support constructions may additionally include modeling material formulation elements, e.g. for further support strength.

The modeling material formulation is generally a composition which is formulated for use in additive manufacturing and which is able to form a three-dimensional object on its own, i.e., without having to be mixed or combined with any other substance.

The final three-dimensional object is made of the modeling material formulation or a combination of modeling material formulations or modeling and support material formulations or modification thereof (e.g., following curing). All these operations are well-known to those skilled in the art of solid freeform fabrication.

In some exemplary embodiments of the invention an object is manufactured by dispensing two or more different modeling material formulations, each material formulation from a different array of nozzles (belonging to the same or different printing heads) of the AM apparatus. In some embodiments, two or more such arrays of nozzles that dispense different modeling material formulations are both located in the same printing head of the AM apparatus. In some embodiments, arrays of nozzles that dispense different modeling material formulations are located in separate printing heads, for example, a first array of nozzles dispensing a first modeling material formulation is located in a first printing head, and a second array of nozzles dispensing a second modeling material formulation is located in a second printing head.

In some embodiments, an array of nozzles that dispense a modeling material formulation and an array of nozzles that dispense a support material formulation are both located in the same printing head. In some embodiments, an array of nozzles that dispense a modeling material formulation and an array of nozzles that dispense a support material formulation are located in separate printing heads.

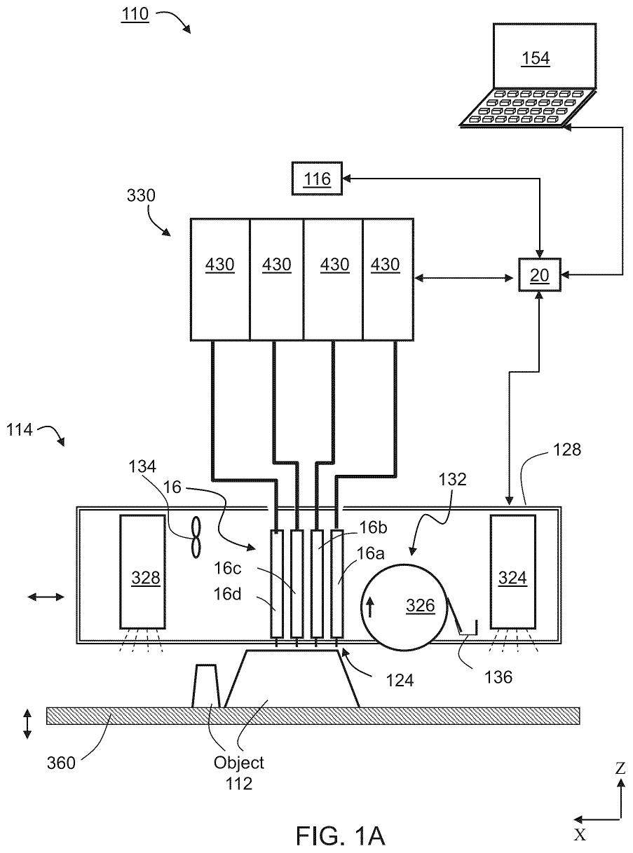

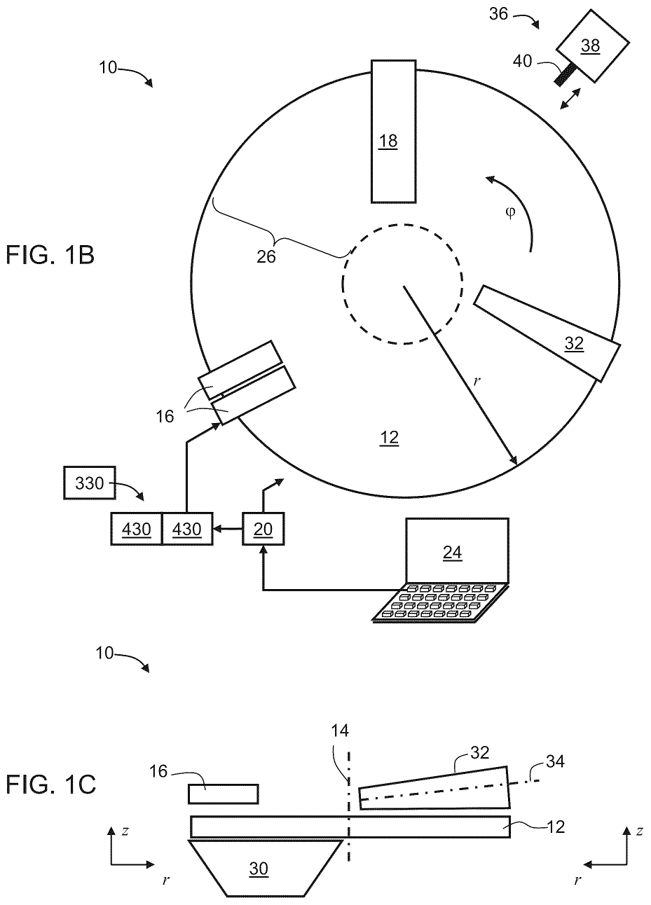

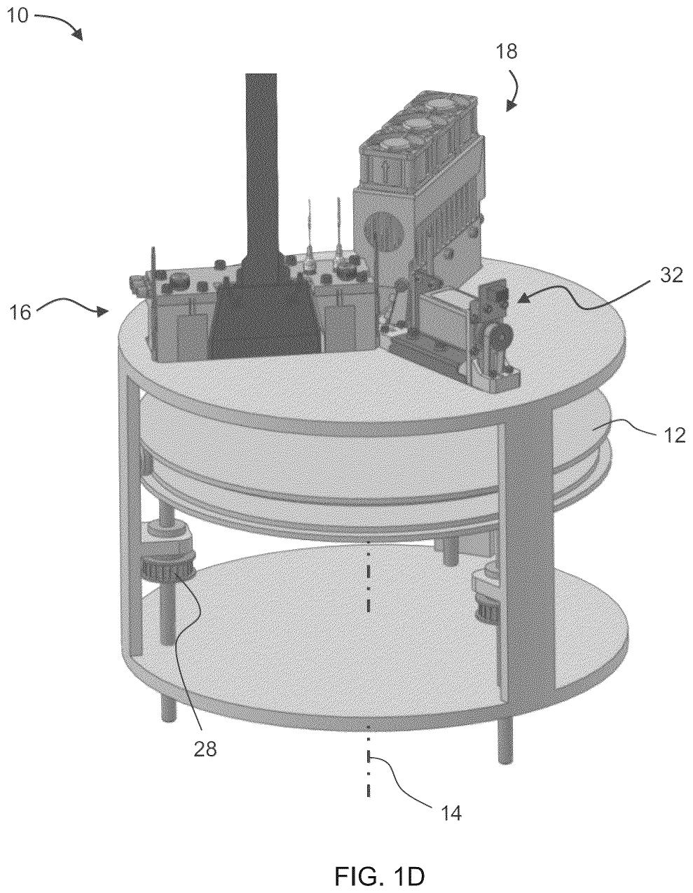

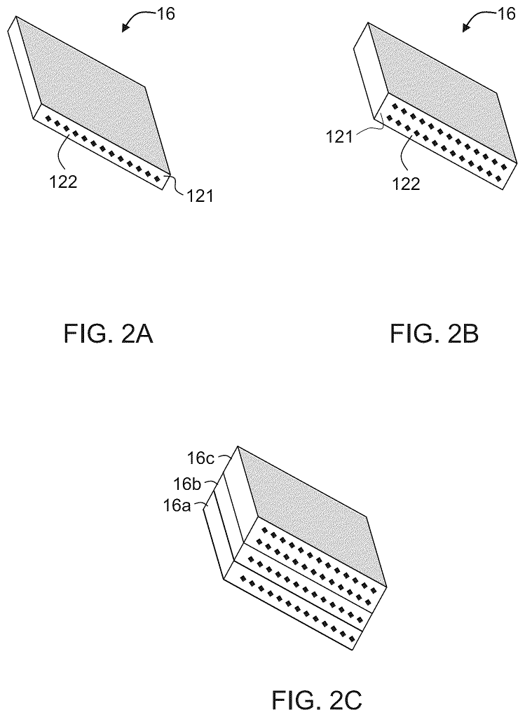

A representative and non-limiting example of a system 110 suitable for AM of an object 112 according to some embodiments of the present invention is illustrated in FIG. 1A. System 110 comprises an additive manufacturing apparatus 114 having a dispensing unit 16 which comprises a plurality of printing heads. Each head preferably comprises one or more arrays of nozzles 122, typically mounted on an orifice plate 121, as illustrated in FIGS. 2A-C described below, through which a liquid building material formulation 124 is dispensed.

Preferably, but not obligatorily, apparatus 114 is a three-dimensional printing apparatus, in which case the printing heads are printing heads, and the building material formulation is dispensed via inkjet technology. This need not necessarily be the case, since, for some applications, it may not be necessary for the additive manufacturing apparatus to employ three-dimensional printing techniques. Representative examples of additive manufacturing apparatus contemplated according to various exemplary embodiments of the present invention include, without limitation, fused deposition modeling apparatus and fused material formulation deposition apparatus.

Each printing head is optionally and preferably fed via one or more building material formulation reservoirs which may optionally include a temperature control unit (e.g., a temperature sensor and/or a heating device), and a material formulation level sensor. To dispense the building material formulation, a voltage signal is applied to the printing heads to selectively deposit droplets of material formulation via the printing head nozzles, for example, as in piezoelectric inkjet printing technology. Another example includes thermal inkjet printing heads. In these types of heads, there are heater elements in thermal contact with the building material formulation, for heating the building material formulation to form gas bubbles therein, upon activation of the heater elements by a voltage signal. The gas bubbles generate pressures in the building material formulation, causing droplets of building material formulation to be ejected through the nozzles. Piezoelectric and thermal printing heads are known to those skilled in the art of solid freeform fabrication. For any types of inkjet printing heads, the dispensing rate of the head depends on the number of nozzles, the type of nozzles and the applied voltage signal rate (frequency).

Optionally, the overall number of dispensing nozzles or nozzle arrays is selected such that half of the dispensing nozzles are designated to dispense support material formulation and half of the dispensing nozzles are designated to dispense modeling material formulation, i.e. the number of nozzles jetting modeling material formulations is the same as the number of nozzles jetting support material formulation. In the representative example of FIG. 1A, four printing heads 16a, 16b, 16c and 16d are illustrated. Each of heads 16a, 16b, 16c and 16d has a nozzle array. In this Example, heads 16a and 16b can be designated for modeling material formulation/s and heads 16c and 16d can be designated for support material formulation. Thus, head 16a can dispense one modeling material formulation, head 16b can dispense another modeling material formulation and heads 16c and 16d can both dispense support material formulation. In an alternative embodiment, heads 16c and 16d, for example, may be combined in a single head having two nozzle arrays for depositing support material formulation. In a further alternative embodiment any one or more of the printing heads may have more than one nozzle arrays for depositing more than one material formulation, e.g. two nozzle arrays for depositing two different modeling material formulations or a modeling material formulation and a support material formulation, each formulation via a different array or number of nozzles.

Yet it is to be understood that it is not intended to limit the scope of the present invention and that the number of modeling material formulation printing heads (modeling heads) and the number of support material formulation printing heads (support heads) may differ. Generally, the number of arrays of nozzles that dispense modeling material formulation, the number of arrays of nozzles that dispense support material formulation, and the number of nozzles in each respective array are selected such as to provide a predetermined ratio, a, between the maximal dispensing rate of the support material formulation and the maximal dispensing rate of modeling material formulation. The value of the predetermined ratio, a, is preferably selected to ensure that in each formed layer, the height of modeling material formulation equals the height of support material formulation. Typical values for a are from about 0.6 to about 1.5.

As used herein throughout the term “about” refers to ±10%.

For example, for a=1, the overall dispensing rate of support material formulation is generally the same as the overall dispensing rate of the modeling material formulation when all the arrays of nozzles operate.

Apparatus 114 can comprise, for example, M modeling heads each having m arrays of p nozzles, and S support heads each having s arrays of q nozzles such that M×m×p=S×s×q. Each of the M×m modeling arrays and S×s support arrays can be manufactured as a separate physical unit, which can be assembled and disassembled from the group of arrays. In this embodiment, each such array optionally and preferably comprises a temperature control unit and a material formulation level sensor of its own, and receives an individually controlled voltage for its operation.

Apparatus 114 can further comprise a solidifying device 324 which can include any device configured to emit light, heat or the like that may cause the deposited material formulation to harden. For example, solidifying device 324 can comprise one or more radiation sources, which can be, for example, an ultraviolet or visible or infrared lamp, or other sources of electromagnetic radiation, or electron beam source, depending on the modeling material formulation being used. In some embodiments of the present invention, solidifying device 324 serves for curing or solidifying the modeling material formulation.

In addition to solidifying device 324, apparatus 114 optionally and preferably comprises an additional radiation source 328 for solvent evaporation. Radiation source 328 optionally and preferably generates infrared radiation. In various exemplary embodiments of the invention solidifying device 324 comprises a radiation source generating ultraviolet radiation, and radiation source 328 generates infrared radiation.

In some embodiments of the present invention apparatus 114 comprises cooling system 134 such as one or more fans or the like

The printing head(s) and radiation source are preferably mounted in a frame or block 128 which is preferably operative to reciprocally move over a tray 360, which serves as the working surface. In some embodiments of the present invention the radiation sources are mounted in the block such that they follow in the wake of the printing heads to at least partially cure or solidify the material formulations just dispensed by the printing heads. Tray 360 is positioned horizontally. According to the common conventions an X-Y-Z Cartesian coordinate system is selected such that the X-Y plane is parallel to tray 360. Tray 360 is preferably configured to move vertically (along the Z direction), typically downward. In various exemplary embodiments of the invention, apparatus 114 further comprises one or more leveling devices 132, e.g. a roller 326. Leveling device 326 serves to straighten, level and/or establish a thickness of the newly formed layer prior to the formation of the successive layer thereon. Leveling device 326 preferably comprises a waste collection device 136 for collecting the excess material formulation generated during leveling. Waste collection device 136 may comprise any mechanism that delivers the material formulation to a waste tank or waste cartridge.

In use, the printing heads of unit 16 move in a scanning direction, which is referred to herein as the X direction, and selectively dispense building material formulation in a predetermined configuration in the course of their passage over tray 360. The building material formulation typically comprises one or more types of support material formulation and one or more types of modeling material formulation. The passage of the printing heads of unit 16 is followed by the curing of the modeling material formulation(s) by radiation source 126. In the reverse passage of the heads, back to their starting point for the layer just deposited, an additional dispensing of building material formulation may be carried out, according to predetermined configuration. In the forward and/or reverse passages of the printing heads, the layer thus formed may be straightened by leveling device 326, which preferably follows the path of the printing heads in their forward and/or reverse movement. Once the printing heads return to their starting point along the X direction, they may move to another position along an indexing direction, referred to herein as the Y direction, and continue to build the same layer by reciprocal movement along the X direction. Alternately, the printing heads may move in the Y direction between forward and reverse movements or after more than one forward-reverse movement. The series of scans performed by the printing heads to complete a single layer is referred to herein as a single scan cycle.

Once the layer is completed, tray 360 is lowered in the Z direction to a predetermined Z level, according to the desired thickness of the layer subsequently to be printed. The procedure is repeated to form three-dimensional object 112 in a layerwise manner.

In another embodiment, tray 360 may be displaced in the Z direction between forward and reverse passages of the printing head of unit 16, within the layer. Such Z displacement is carried out in order to cause contact of the leveling device with the surface in one direction and prevent contact in the other direction.

The present embodiments contemplate use of a liquid material formulation supply system 330, which comprises one or more liquid material containers or cartridges 430, and which supplies the liquid material(s) to printing heads. Supply system 330 can be used in an AM system such as system 110, in which case the liquid material in each container is a building material, or in a two-dimensional printing system in which case the liquid material in each container can be ink or any other formulation suitable for 2D printing.

A controller 20 controls fabrication apparatus 114 and optionally and preferably also supply system 330. Controller 20 typically includes an electronic circuit configured to perform the controlling operations. Controller 20 preferably communicates with a data processor 154 which transmits digital data pertaining to fabrication instructions based on computer object data, e.g., a CAD configuration represented on a computer readable medium in a form of a Standard Tessellation Language (STL) format or the like. Typically, controller 20 controls the voltage applied to each printing head or each nozzle array and the temperature of the building material formulation in the respective printing head or respective nozzle array.

Once the manufacturing data is loaded to controller 20 it can operate without user intervention. In some embodiments, controller 20 receives additional input from the operator, e.g., using data processor 154 or using a user interface 116 communicating with controller 20. User interface 116 can be of any type known in the art, such as, but not limited to, a keyboard, a touch screen and the like. For example, controller 20 can receive, as additional input, one or more building material formulation types and/or attributes, such as, but not limited to, color, characteristic distortion and/or transition temperature, viscosity, electrical property, magnetic property. Other attributes and groups of attributes are also contemplated.

Another representative and non-limiting example of a system 10 suitable for AM of an object according to some embodiments of the present invention is illustrated in FIGS. 1B-D. FIGS. 1B-D illustrate a top view (FIG. 1B), a side view (FIG. 1C) and an isometric view (FIG. 1D) of system 10.

In the present embodiments, system 10 comprises a tray 12 and a plurality of inkjet printing heads 16, each having one or more arrays of nozzles with respective one or more pluralities of separated nozzles. The material used for the three-dimensional printing is supplied to heads 16 by building material supply system 330, with one or more liquid material containers or cartridges 430, as further detailed hereinabove. Tray 12 can have a shape of a disk or it can be annular. Non-round shapes are also contemplated, provided they can be rotated about a vertical axis.

Tray 12 and heads 16 are optionally and preferably mounted such as to allow a relative rotary motion between tray 12 and heads 16. This can be achieved by (i) configuring tray 12 to rotate about a vertical axis 14 relative to heads 16, (ii) configuring heads 16 to rotate about vertical axis 14 relative to tray 12, or (iii) configuring both tray 12 and heads 16 to rotate about vertical axis 14 but at different rotation velocities (e.g., rotation at opposite direction). While some embodiments of system 10 are described below with a particular emphasis to configuration (i) wherein the tray is a rotary tray that is configured to rotate about vertical axis 14 relative to heads 16, it is to be understood that the present application contemplates also configurations (ii) and (iii) for system 10. Any one of the embodiments of system 10 described herein can be adjusted to be applicable to any of configurations (ii) and (iii), and one of ordinary skills in the art, provided with the details described herein, would know how to make such adjustment.

In the following description, a direction parallel to tray 12 and pointing outwardly from axis 14 is referred to as the radial direction r, a direction parallel to tray 12 and perpendicular to the radial direction r is referred to herein as the azimuthal direction φ, and a direction perpendicular to tray 12 is referred to herein is the vertical direction z.

The radial direction r in system 10 enacts the indexing direction y in system 110, and the azimuthal direction φ enacts the scanning direction x in system 110. Therefore, the radial direction is interchangeably referred to herein as the indexing direction, and the azimuthal direction is interchangeably referred to herein as the scanning direction.

The term “radial position,” as used herein, refers to a position on or above tray 12 at a specific distance from axis 14. When the term is used in connection to a printing head, the term refers to a position of the head which is at specific distance from axis 14. When the term is used in connection to a point on tray 12, the term corresponds to any point that belongs to a locus of points that is a circle whose radius is the specific distance from axis 14 and whose center is at axis 14.

The term “azimuthal position,” as used herein, refers to a position on or above tray 12 at a specific azimuthal angle relative to a predetermined reference point. Thus, radial position refers to any point that belongs to a locus of points that is a straight line forming the specific azimuthal angle relative to the reference point.

The term “vertical position,” as used herein, refers to a position over a plane that intersect the vertical axis 14 at a specific point.

Tray 12 serves as a building platform for three-dimensional printing. The working area on which one or objects are printed is typically, but not necessarily, smaller than the total area of tray 12. In some embodiments of the present invention the working area is annular. The working area is shown at 26. In some embodiments of the present invention tray 12 rotates continuously in the same direction throughout the formation of object, and in some embodiments of the present invention tray reverses the direction of rotation at least once (e.g., in an oscillatory manner) during the formation of the object. Tray 12 is optionally and preferably removable. Removing tray 12 can be for maintenance of system 10, or, if desired, for replacing the tray before printing a new object. In some embodiments of the present invention system 10 is provided with one or more different replacement trays (e.g., a kit of replacement trays), wherein two or more trays are designated for different types of objects (e.g., different weights) different operation modes (e.g., different rotation speeds), etc. The replacement of tray 12 can be manual or automatic, as desired. When automatic replacement is employed, system 10 comprises a tray replacement device 36 configured for removing tray 12 from its position below heads 16 and replacing it by a replacement tray (not shown). In the representative illustration of FIG. 1B tray replacement device 36 is illustrated as a drive 38 with a movable arm 40 configured to pull tray 12, but other types of tray replacement devices are also contemplated.

Exemplified embodiments for the printing head 16 are illustrated in FIGS. 2A-2C. These embodiments can be employed for any of the AM systems described above, including, without limitation, system 110 and system 10.

FIGS. 2A-B illustrate a printing head 16 with one (FIG. 2A) and two (FIG. 2B) nozzle arrays 22. The nozzles in the array are preferably aligned linearly, along a straight line. Printing head 16 is fed by a liquid material and dispenses it through the nozzle arrays 22, in response to a voltage signal applied thereto by the controller of the printing system. Head 16 can be used for two-dimensional or three-dimensional printing. When head 16 is used for three-dimensional printing, it is fed by a liquid material which is a building material formulation, and when head 16 is used for two-dimensional printing it is fed by a liquid material which is preferably ink or any other formulation suitable for 2D printing.

In embodiments in which a particular printing head has two or more linear nozzle arrays, the nozzle arrays are optionally and preferably can be parallel to each other. When a printing head has two or more arrays of nozzles (e.g., FIG. 2B) all arrays of the head can be fed with the same building material formulation, or at least two arrays of the same head can be fed with different building material formulations.

When a system similar to system 110 is employed, all printing heads 16 are optionally and preferably oriented along the indexing direction with their positions along the scanning direction being offset to one another.

When a system similar to system 10 is employed, all printing heads 16 are optionally and preferably oriented radially (parallel to the radial direction) with their azimuthal positions being offset to one another. Thus, in these embodiments, the nozzle arrays of different printing heads are not parallel to each other but are rather at an angle to each other, which angle being approximately equal to the azimuthal offset between the respective heads. For example, one head can be oriented radially and positioned at azimuthal position φ₁, and another head can be oriented radially and positioned at azimuthal position φ₂. In this example, the azimuthal offset between the two heads is φ₁-φ₂, and the angle between the linear nozzle arrays of the two heads is also φ₁-φ₂.

In some embodiments, two or more printing heads can be assembled to a block of printing heads, in which case the printing heads of the block are typically parallel to each other. A block including several inkjet printing heads 16a, 16b, 16c is illustrated in FIG. 2C.

In some embodiments, system 10 comprises a stabilizing structure 30 positioned below heads 16 such that tray 12 is between stabilizing structure 30 and heads 16. Stabilizing structure 30 may serve for preventing or reducing vibrations of tray 12 that may occur while inkjet printing heads 16 operate. In configurations in which printing heads 16 rotate about axis 14, stabilizing structure 30 preferably also rotates such that stabilizing structure 30 is always directly below heads 16 (with tray 12 between heads 16 and tray 12).

Tray 12 and/or printing heads 16 is optionally and preferably configured to move along the vertical direction z, parallel to vertical axis 14 so as to vary the vertical distance between tray 12 and printing heads 16. In configurations in which the vertical distance is varied by moving tray 12 along the vertical direction, stabilizing structure 30 preferably also moves vertically together with tray 12. In configurations in which the vertical distance is varied by heads 16 along the vertical direction, while maintaining the vertical position of tray 12 fixed, stabilizing structure 30 is also maintained at a fixed vertical position.

The vertical motion can be established by a vertical drive 28. Once a layer is completed, the vertical distance between tray 12 and heads 16 can be increased (e.g., tray 12 is lowered relative to heads 16) by a predetermined vertical step, according to the desired thickness of the layer subsequently to be printed. The procedure is repeated to form a three-dimensional object in a layerwise manner.

The operation of inkjet printing heads 16 and optionally and preferably also of one or more other components of system 10, e.g., the motion of tray 12, are controlled by a controller 20. The controller can have an electronic circuit and a non-volatile memory medium readable by the circuit, wherein the memory medium stores program instructions which, when read by the circuit, cause the circuit to perform control operations as further detailed below.

Controller 20 can also communicate with a host computer 24 which transmits digital data pertaining to fabrication instructions based on computer object data, e.g., in a form of a Standard Tessellation Language (STL) or a StereoLithography Contour (SLC) format, Virtual Reality Modeling Language (VRML), Additive Manufacturing File (AMF) format, Drawing Exchange Format (DXF), Polygon File Format (PLY) or any other format suitable for Computer-Aided Design (CAD). The object data formats are typically structured according to a Cartesian system of coordinates. In these cases, computer 24 preferably executes a procedure for transforming the coordinates of each slice in the computer object data from a Cartesian system of coordinates into a polar system of coordinates. Computer 24 optionally and preferably transmits the fabrication instructions in terms of the transformed system of coordinates. Alternatively, computer 24 can transmit the fabrication instructions in terms of the original system of coordinates as provided by the computer object data, in which case the transformation of coordinates is executed by the circuit of controller 20.

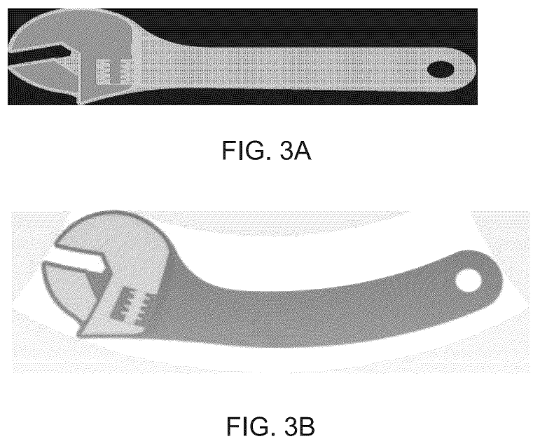

The transformation of coordinates allows three-dimensional printing over a rotating tray. In non-rotary systems with a stationary tray with the printing heads typically reciprocally move above the stationary tray along straight lines. In such systems, the printing resolution is the same at any point over the tray, provided the dispensing rates of the heads are uniform. In system 10, unlike non-rotary systems, not all the nozzles of the head points cover the same distance over tray 12 during at the same time. The transformation of coordinates is optionally and preferably executed so as to ensure equal amounts of excess material formulation at different radial positions. Representative examples of coordinate transformations according to some embodiments of the present invention are provided in FIGS. 3A-B, showing three slices of an object (each slice corresponds to fabrication instructions of a different layer of the objects), where FIG. 3A illustrates a slice in a Cartesian system of coordinates and FIG. 3B illustrates the same slice following an application of a transformation of coordinates procedure to the respective slice.

Typically, controller 20 controls the voltage applied to the respective component of the system 10 based on the fabrication instructions and based on the stored program instructions as described below.

Generally, controller 20 controls printing heads 16 to dispense, during the rotation of tray 12, droplets of building material formulation in layers, such as to print a three-dimensional object on tray 12.

System 10 optionally and preferably comprises one or more radiation sources 18, which can be, for example, an ultraviolet or visible or infrared lamp, or other sources of electromagnetic radiation, or electron beam source, depending on the modeling material formulation being used. Radiation source can include any type of radiation emitting device, including, without limitation, light emitting diode (LED), digital light processing (DLP) system, resistive lamp and the like. Radiation source 18 serves for curing or solidifying the modeling material formulation. In various exemplary embodiments of the invention the operation of radiation source 18 is controlled by controller 20 which may activate and deactivate radiation source 18 and may optionally also control the amount of radiation generated by radiation source 18.

In some embodiments of the invention, system 10 further comprises one or more leveling devices 32 which can be manufactured as a roller or a blade. Leveling device 32 serves to straighten the newly formed layer prior to the formation of the successive layer thereon. In some embodiments, leveling device 32 has the shape of a conical roller positioned such that its symmetry axis 34 is tilted relative to the surface of tray 12 and its surface is parallel to the surface of the tray. This embodiment is illustrated in the side view of system 10 (FIG. 1C).

The conical roller can have the shape of a cone or a conical frustum.

The opening angle of the conical roller is preferably selected such that there is a constant ratio between the radius of the cone at any location along its axis 34 and the distance between that location and axis 14. This embodiment allows roller 32 to efficiently level the layers, since while the roller rotates, any point p on the surface of the roller has a linear velocity which is proportional (e.g., the same) to the linear velocity of the tray at a point vertically beneath point p. In some embodiments, the roller has a shape of a conical frustum having a height h, a radius R₁ at its closest distance from axis 14, and a radius R₂ at its farthest distance from axis 14, wherein the parameters h, R₁ and R₂ satisfy the relation R₁/R₂=(R−h)/h and wherein R is the farthest distance of the roller from axis 14 (for example, R can be the radius of tray 12).

The operation of leveling device 32 is optionally and preferably controlled by controller 20 which may activate and deactivate leveling device 32 and may optionally also control its position along a vertical direction (parallel to axis 14) and/or a radial direction (parallel to tray 12 and pointing toward or away from axis 14.

In some embodiments of the present invention printing heads 16 are configured to reciprocally move relative to tray along the radial direction r. These embodiments are useful when the lengths of the nozzle arrays 22 of heads 16 are shorter than the width along the radial direction of the working area 26 on tray 12. The motion of heads 16 along the radial direction is optionally and preferably controlled by controller 20.

Some embodiments contemplate the fabrication of an object by dispensing different material formulations from different arrays of nozzles (belonging to the same or different printing head). These embodiments provide, inter alia, the ability to select material formulations from a given number of material formulations and define desired combinations of the selected material formulations and their properties. According to the present embodiments, the spatial locations of the deposition of each material formulation with the layer is defined, either to effect occupation of different three-dimensional spatial locations by different material formulations, or to effect occupation of substantially the same three-dimensional location or adjacent three-dimensional locations by two or more different material formulations so as to allow post deposition spatial combination of the material formulations within the layer, thereby to form a composite material formulation at the respective location or locations.

Any post deposition combination or mix of modeling material formulations is contemplated. For example, once a certain material formulation is dispensed it may preserve its original properties. However, when it is dispensed simultaneously with another modeling material formulation or other dispensed material formulations which are dispensed at the same or nearby locations, a composite material formulation having a different property or properties to the dispensed material formulations may be formed.

In some embodiments of the present invention the system dispenses digital material formulation for at least one of the layers.

The phrase “digital material formulations”, as used herein and in the art, describes a combination of two or more material formulations on a pixel level or voxel level such that pixels or voxels of different material formulations are interlaced with one another over a region. Such digital material formulations may exhibit new properties that are affected by the selection of types of material formulations and/or the ratio and relative spatial distribution of two or more material formulations.

As used herein, a “voxel” of a layer refers to a physical three-dimensional elementary volume within the layer that corresponds to a single pixel of a bitmap describing the layer. The size of a voxel is approximately the size of a region that is formed by a building material, once the building material is dispensed at a location corresponding to the respective pixel, leveled, and solidified.

The present embodiments thus enable the deposition of a broad range of material formulation combinations, and the fabrication of an object which may consist of multiple different combinations of material formulations, in different parts of the object, according to the properties desired to characterize each part of the object.

Further details on the principles and operations of an AM system suitable for the present embodiments are found in U.S. Pat. No. 9,031,680, the contents of which are hereby incorporated by reference.

In the field of inkjet printing, particularly in the field of three-dimensional inkjet printing but also in the field of two-dimensional inkjet printing, it is oftentimes desired to analyze the jetting characteristics of the printing system. For example, it is advantageous to determine the average size (e.g., weight, mass, volume) of a single drop dispensed by the printing head. One advantage of such a determination is that it allows setting a proper level for the voltage signal that is applied to the printing head, in order to reduce drop size variability during printing, thereby improving the quality of the pattern printed by the head. It is also advantageous to determine the number of defective (or, complementary, the number of properly operative) nozzles of a particular printing head. One advantage of such a determination is that it allows identifying individual defective nozzles in the head, and executing a printing compensation protocol that compensates for printing pattern irregularities caused by those defective nozzles.

Several techniques have been heretofore suggested for determining the average drop size, and to identify defective nozzles. One such technique requires dispensing a bulk having a predefined size and shape (number of drops) onto a surface, and measuring the weight of the resulting bulk using an accurate weight measuring device (e.g., load cell or the like). Another such technique requires dispensing a predetermined shape on a surface and performing optical examination thereafter using an optical inspection system. Also known, are optical techniques, such as stroboscopic measurements, and laser blocking. In stroboscopic measurements, the drops are illuminated on the fly by a stroboscope and images of the illuminated drops are captured. Image processing techniques are then applied to calculate the average volume of the drops. In laser blocking, a laser beam is directed to cross the flight path of the drops, and the time period during which the beam is blocked by the drops is measured. The drops' diameters are then calculated based on the measured time and information pertaining to the velocity of the drop. Further known are electrical techniques. In these techniques, drops are dispensed through an electrical capacitor, and changes in the capacitance of the capacitor are measured and used to determine the volume of the drops. Some of these techniques are summarized in U.S. Published Application No. 20040027405.

The Inventors found that conventional techniques for analyzing jetting characteristics are costly, technologically difficult to employ, or otherwise not practical. For example, techniques in which separate printing of predetermined shapes are time consuming since they require regular interruptions of the printing process, or allocating in advance specific testing times at which the printing system is taken out of use. Additionally, accurate weight measuring devices and optical inspection systems are expensive, leading to an increased cost of the printing system and/or its maintenance. Techniques in which measurements are performed during drop flights require sophisticated and expensive equipment, or otherwise provide inaccurate results. For these reasons, these techniques have met with little commercial acceptance. In a search for an efficient and less expensive technique for determining jetting characteristics of a printing head, the Inventors of the present invention realized and experimentally verified that many jetting characteristics can be determined with sufficient accuracy by pressure measurements.

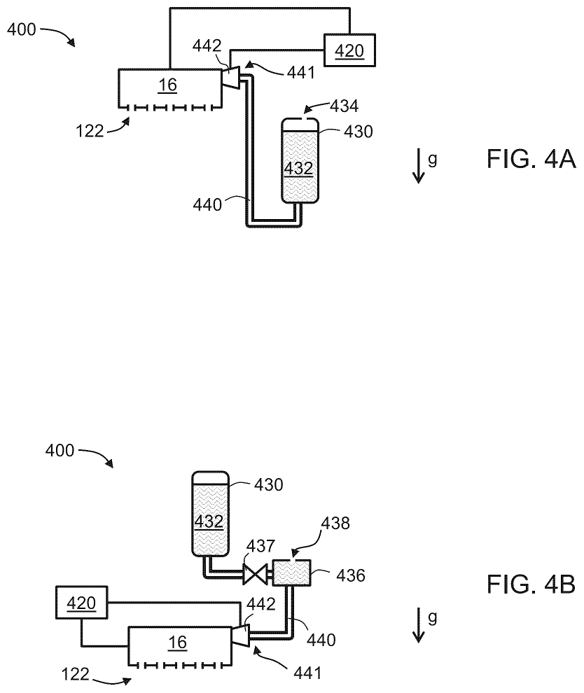

FIGS. 4A and 4B are schematic illustrations showing a printing system 400 according to some embodiments of the present invention. Printing system 400 can be a system for performing two-dimensional printing or three-dimensional printing. When system 400 performs three-dimensional printing it can include one or more of the additional components described above with respect to systems 10 and 110. System 400 comprises one or more inkjet printing heads 16 having a plurality of nozzles 122, and a container 430, containing a liquid material 432 and being in fluid communication with head 16 by a conduit 440, for feeding head 16 with liquid material 432.

For clarity of presentation, the printing head and the container that supplies the liquid material are designated in FIGS. 4A and 4B with the same reference signs as the printing head and the container of systems 10 and 110 (reference signs 16 and 430, respectively) which is described above mainly in the context of three-dimensional printing, but it is to be understood that the container and the printing head of system 400 can be configured for supplying and dispensing liquid material suitable for two-dimensional printing or three-dimensional printing.

FIG. 4A schematically illustrates a configuration in which the container 430 is at a level that is below head 16, so that the liquid material is supplied to head 16 against the direction of the gravity g. This is ensured by generating an under-pressure in head 16, by means of a pump (not shown). In this configuration, container 430 optionally and preferably comprises an opening 434 to the atmosphere, so that the pressure at the upper portion of container 430 is an atmospheric pressure. In this configuration, the supply of material 432 into head 16 can be ensured by generating in head 16 a pressure that is less than the atmospheric pressure. FIG. 4B schematically illustrates a configuration in which the container 430 is at a level that is above head 16, so that the liquid material is supplied to head 16 at least in part by the gravitational force acting along the direction of the gravity g. In some embodiments of the present invention, container 430 feeds head 16 via a sub-tank 436 which receives the liquid material 432 from container 430 and which has an opening 438 to the atmosphere. Preferably, a controllable valve 437 is provided between container 430 and sub-tank 436 to prevent overfilling of sub-tank 436 and leakage through opening 438. For example, valve 437 can be operated to block flow of material 432 from container 430 into sub-tank 436 when there is no flow through conduit 440 (e.g., when there is no under pressure in head 16).

In any event, conduit 440 feeds head 16 with liquid material 432, either directly from container 430 or via sub-tank 436.

System 400 preferably comprises a pressure sensor 442 that generates a signal indicative of a pressure at the outlet 441 of conduit 440.

The pressure sensor 442 can be, for example, a capacitive or piezoresistive micro-machined pressure sensor that may be integrated on top of a read-out ASIC, or a CMOS capacitive pressure sensor. Pressure sensors suitable for the present embodiments are marketed by NXP Semiconductors N.V., Eindhoven, Netherlands. It is expected, however, that during the life of a patent maturing from this application many relevant sensors for measuring pressure will be developed and the scope of the term pressure sensor is intended to include all such new technologies a priori.

The Inventors of the present invention verified experimentally that information pertaining to the change in the pressure at the outlet 441 of conduit 440 over a predetermined jetting time dt is sufficient for determining many jetting characteristics. Thus, in various exemplary embodiments of the invention system 400 comprises a controller 420 that controls head 16 to dispense through nozzles 122 liquid material 432 received via conduit 440, by applying voltage to head 16 as further detailed hereinabove. Controller 420 optionally and preferably also controls valve 437 to prevent overfilling of sub-tank 436. When system 400 is embodied within system 10 or 110, all the operations described herein with respect to controller 420, can be executed by controller 20.

Controller 420 is preferably also configured to calculate one or more jetting characteristics based on the change in the pressure over the predetermined jetting time dt.

One of the jetting characteristics calculated by controller 420 is optionally and preferably the mass flow rate through the nozzles. A description of a mathematical procedure that controller 420 can execute in order to calculate the mass flow rate is provided below. Other jetting characteristics, such as, but not limited to, average drop mass, mass change per number of dispensing events, number of operative nozzles, and the like, correlates to the mass flow rate and can therefore be determined based on the calculated mass flow rate.

It is to be understood, however, that it is not necessary for controller 420 to explicitly determine mass flow rate, and that a jetting characteristic can be determined without explicitly determining the mass flow rate. For example, suppose that the mass flow rate relates to the change in the pressure through some function F. Suppose further that it is deserted to calculate the jetted mass, by multiplying the mass flow rate by some time interval AT. The controller can either calculate the value of the function F thereby providing the mass flow rate explicitly, and then multiply this value by ΔT, or, alternatively, controller can calculate the value of the multiplication function FΔT, without explicitly expressing the value of F.

In some embodiments of the present invention controller 420 calculates the jetting characteristic(s) while fabricating a printed pattern according to print data it received from an external source (e.g., a computer, not shown in FIGS. 4A and 4B, see FIGS. 1A-B). The advantage of these embodiments is that they allow obtaining the jetting characteristic(s) without interrupting the printing process or allocating specific testing times in advance, since there is no need to print predetermined shapes in order to analyze or inspect them. When controller 420 calculates the jetting characteristic(s) while fabricating a printed pattern, a noise reduction procedure is optionally and preferably executed. A preferred noise reduction procedure suitable for the present embodiments is provided in the Examples section that follows.

Following is a description of a preferred procedure that can be executed by controller 420 for estimating the mass flow rate dm/dt. The mass flow rate can be estimated based on the change dH in the height of material in the container over the jetting time dt. The Inventors found that the height of the material in the container correlates with the pressure measured by sensor 442 between successive dispensing events of the dispensing head. When there is no flow of material within conduit 440, the pressure at the outlet 441 of conduit 440 is a static pressure, due to the gravitational force, without contribution of a dynamic pressure. Denoting the difference between the static pressure before and after a dispensing event of the dispensing head by dP_{g}, the change dH in the height of the material in the container as a result of the dispensing is given by dP_{g}=ρ·g·dH, where ρ is the density of the liquid material in the container and g is the gravitational acceleration (about 9.8 m/s²). The mass flow rate dm/dt can thus be calculated as dm/dt=S·dP_{g}/dt, where S is the cross-sectional area of conduit 440.

In some embodiments of the present invention controller 420 calculates the average drop mass. This can be done by first estimating the ratio α between the change dP_{f} in the dynamic pressure at the outlet 441 of conduit 440 over the predetermined jetting time dt and the mass flow rate dm/dt over this jetting time, and then using this estimated ratio to calculate the average drop mass. Preferably, the average drop mass is calculated by dividing the change dP_{f} in the dynamic pressure by the estimated ratio α, by the dispensing frequency, and by the number of nozzles in array 122.

The ratio α between dP_{f} and dm/dt can be found in more than one way. Generally, the ratio α depends on the geometry of conduit 440 and the mechanical properties (e.g., viscosity) of the building material. Thus, for example, for a given conduit 440 that is used by system 400, the ratio α can be derived using, e.g., a lookup table that is prepared in advance and that provides the ratio α for each of several building materials that are usable by the system. Alternatively, or in case system 400 uses a building material not listed in the lookup table, the ratio α can be measured by applying a predetermined flow rate dm/dt, measuring the corresponding change dP_{f} in the dynamic pressure, and calculating α as the ratio between the applied predetermined flow rate and the measured change dP_{f} in the dynamic pressure. Also contemplated, are embodiments in which both dm/dt and dP_{f} are measured, in which case α is estimated as the ratio between the measured value of dm/dt and the measured value of dP_{f}. In the latter embodiments, the value of dm/dt can be measured by an additional device (not shown) such as, but not limited to, a flow meter, a load cell or the like.

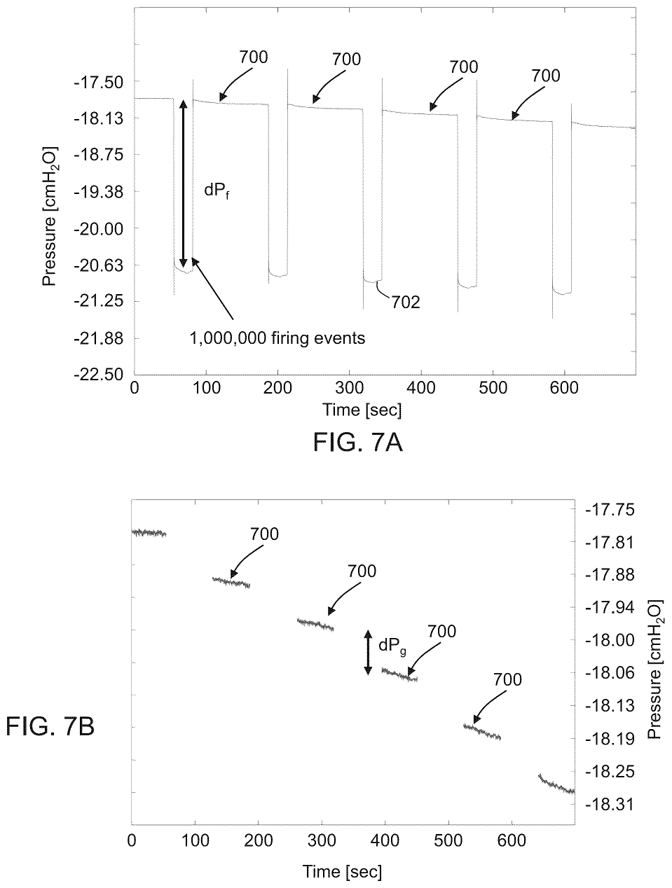

The Inventors found that both the change dP_{f} in the dynamic pressure and the change dP_{g} in the static pressure can be estimated using the same pressure sensor 442. This can be better understood with reference to FIGS. 7A and 7B. FIG. 7A shows a typical pressure profile at the outlet 441 of conduit 440, during a sequence of dispensing events of the printing head. As shown, the pressure profile includes a gradually decreasing baseline 700 and short abrupt pressure changes 702. The Inventors found that the depths of the changes 702 can be used as the change dP_{f} of the dynamic pressure. FIG. 7B shows a zoom-in along the ordinate of FIG. 7A. This graph shows the gradual decrease of the baseline 700. The Inventors found that the change in the level of the baseline 700 between successive abrupt changes can be used as the change dP_{g} of the static pressure.

In some embodiments of the present invention controller 420 adjusts the voltage applied to head 16 based on the calculated average drop mass. For example, controller 420 can adjust the applied voltage so as to maintain a generally constant average drop mass throughout the printing process. Preferably, such calculation and adjustment is executed in closed loop.

Another jetting characteristic which can be calculated is the number of operative nozzles in the printing head. This can be done for example, by multiplying the average drop mass by the number of nozzles in the head, or by dividing the change in the dynamic pressure by the aforementioned ratio α and by the dispensing frequency. Such calculation effectively provides the derivative of the dispensed mass with respect to the number of dispensing events executed by the head, which correlates linearly with the number of operative nozzles, so that the number of operative nozzles can be extracted using a predetermined linear function of said derivative. As demonstrated in the Examples section that follows, the Inventors found that such calculation provides information pertaining to the number of operative nozzles at high resolution.

Once the number of operative nozzles is obtained, it can be compared to the total number of nozzles in the head. When the number of operative nozzles is less than the total number of nozzles controller 420 can determine that there are defective nozzles, and optionally and preferably issues an alert signal. Controller 420 can in some embodiments of the present invention executes a search procedure to identify a subset of nozzles in which at least one nozzle is defective. For example, Controller 420 can deliberately disable a subset of the nozzles, and repeat the calculation of the number of operative nozzles, except that instead of considering all the nozzles, only those nozzles in the subset are considered. When the number of operative nozzles is less than the total number of nozzles in the subset, controller 420 can determine that there are defective nozzles in the subset. Otherwise, controller 420 can determine that there are defective nozzles in a subset that is complementary to the tested subset. The procedure can be repeated one or more times, with subsets of reduced size, thereby narrowing the search. Preferably, the procedure is repeated until individual defective nozzles are identified.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

### Example 1

### Mathematical Considerations

With reference to FIGS. 4A and 4B, the Inventors found that some jetting characteristics of the head 16 can be assessed based on the pressure measured at the outlet 441 of conduit 440. The Inventors observed that the pressure in the interior of the head 16 relative to the atmosphere is the sum of the static pressure due to the gravitational force acting on the column of liquid in container 430, and the dynamic pressure due to the resistance to flow of the liquid within conduit 440. The change dP in pressure in the interior of the head 16 during the predetermined jetting time dt can thus be written as:

dP=dP_{g}+dP_{f} (EQ. 1)

where dP_{g} is the change in static pressure, dP_{f} is the change in the dynamic pressure.

The change in static pressure dP_{g} is given by the relation:

dP_{g}=ρ·g·dH (EQ. 2)

where ρ is the density of liquid material 432, g is the gravitational acceleration (about 9.8 m/s²) and dH is the change in height of material 432 within container 430. Since the dimensions of the container 430 are known, the amount of liquid in the container correlates with the height H, and therefore with the static pressure dP_{g}.

The flow rate of liquid in conduit 440 is given by dV/dt, where dV is the volume of liquid that flows in conduit 440 during a time period dt. The change in dynamic pressure is proportional to the flow rate dV/dt, the viscosity u of material 432, and the ratio between the length L of conduit 440 and the fourth power of its radius R:

dP_{f}=μ(dV/dt)(L/R⁴). (EQ. 3)

The volume dV appearing in the flow rate can be approximated as S·dH where S is the cross-sectional area of conduit 440. Thus, the flow rate dV/dt relates to the change dP_{g} in static pressure through EQ, 2:

dV/dt=(S/ρ·g)·dP_{g}/dt (EQ.4)

Multiplying both sides of EQ. 4 by ρ, one obtains an expression for the mass flow rate dm/dt:

dm/dt=(S/g)·dP_{g}/dt. (EQ. 5)

Therefore, the ratio α between the change in the dynamic pressure dP_{f} during the predetermined jetting time dt and the mass flow rate dm/dt is given by:

$$\\ \begin{matrix}α = \frac{{dP}_{f}}{dm / dt} = \frac{g}{S} \cdot \frac{{dP}_{f}}{{dP}_{g}} dt & ( EQ . 6 )\end{matrix}$$

Thus, the signal from sensor 442, which is indicative of dP_{f}, can be used to estimate the ratio α.

### Noise Reduction

Following is a description of example noise reduction techniques according to some embodiments of the present invention. Denoting the noise component of the pressure measured by sensor 442 by &, the dynamic pressure dP_{f} is given by:

dP_{f}=Pₘ−P_{g}−ε (EQ. 7)
where Pₘ is the pressure measured by sensor 442, and:

dP=P(t)−P(t−dt)

dP_{f}(t)=P(t,without flow)−P(t,with flow)

dP_{gravity}(t)=P(t,without flow)−P(t−dt,without flow)

Pₘ(t)=P(t)+ε(t).

P_{g}(t)=P(t=0)+∫tₛₜₐᵣₜ^{t}dP_{g}(t)

During a printing process of a two- or three-dimensional object according to computer print data received from an external source (as opposed to a jetting test according to predetermined jetting sequence), both the values of P_{f} and ε vary. Averaging EQ. 7 over time, one obtains:

d̅P̅_̅{̅f̅}̅=P̅ₘ̅−̅P̅_̅{̅g̅}̅−̅ε̅≈P̅ₘ̅−P̅_{g}−ε̅. (EQ. 8)

Since the noise component is random or periodic, its time-average is typically zero, and so the average of EQ. 8 is approximated as:

d̅P̅_̅{̅f̅}̅≈P̅ₘ̅−P̅_{g}. (EQ.9)

The average of the measured pressure Pₘ over N sample time-points is given by P̅ₘ̅=1/NΣᵢ₌₁^{N} Pₘᵢ, where Pₘᵢ is the measurement performed by sensor 442 at the ith sample time-point. The static pressure P_{gi} at the ith sample time-point typically varies linearly with the number V_{di} of drops jetted until the ith sample:

P_{gi}=P_{g0}+αV_{di} (EQ. 10)

where P_{g0} is the static pressure immediately before the ith sample time-point and a is a predetermined slope constant that can be calibrated in advance. For example, the slope constant a can be measured during a calibration procedure with N sample time-points as:

$$\\ \begin{matrix}a = \frac{{P}_{gN} - {P}_{g 0}}{{V}_{dN}} & ( EQ . 11 )\end{matrix}$$

where P_{gN} is the static pressure at the last sample time-point of the calibration procedure, and V_{dN} is the total number of drops ejected during the calibration procedure. In some embodiments of the present invention the measurements at the first and last sample time-points are performed by sensor 442 when the pressure is stable and without jetting. The advantage of these embodiments is that they allow self-calibration, wherein the value of the slope constant a can be obtaining without executing a separate calibration procedure. This is because in these embodiments the static P_{g} and measured Pₘ are approximately the same at each of the first and last sample time-points and so EQ. 11 can be written as:

$$\\ \begin{matrix}a = \frac{{P}_{mN} - {P}_{m 0}}{{V}_{dN}} & ( EQ . 12 )\end{matrix}$$

where Pₘ₀ and P_{mN} are the values of the measured pressure at the first and last sample time-points, respectively.

Once the slope constant is known, the average static pressure can be calculated as:

P̅_̅{̅g̅}̅=α̅V̅_̅{̅d̅i̅}̅+̅P̅ₘ̅₀̅. (EQ. 13)

The average dynamic pressure Pf can then be calculated using EQs. 9, 12 and 13:

d̅P̅_̅{̅f̅}̅≈P̅ₘ̅−P̅_{g}≈P̅ₘ̅−α̅V̅_̅{̅d̅i̅}̅+̅P̅ₘ̅₀̅=P̅ₘ̅−P̅ₘ̅₀̅−αV̅_̅{̅d̅N̅}̅ (EQ. 14)

EQ. 14 provides a substantially noise-free value for the average of the dynamic pressure, which can be used for calculating any of the aforementioned jetting characteristics. For example, the average drop weight can be calculated as d̅P̅_̅{̅f̅}̅/(αd̅V̅_̅{̅d̅t̅}̅/̅d̅t̅), where a is the aforementioned ratio between the change in the pressure at the outlet 441 of conduit 440 over the predetermined jetting time dt and the mass flow rate dm/dt over this jetting time (see EQ. 6).

The present embodiments also contemplate a noise reduction technique in which the noise contribution is estimated and reduced by executing a plurality of independent readings of the pressure sensor 442, using a mathematical procedure that will now be explained.

Taking into account the (time-dependent) noise component by ε(t) EQ. 1 is rewritten as:

dP=dP_{g}+dP_{f}+ε(t). (EQ. 15)

the change dP_{g} in static pressure can be expressed in terms of the mass change dm and the cross-sectional area S of conduit 440, according to the relation dP_{g}=g·dm/S, and change dP_{f} in dynamic pressure can be expressed using EQ. 6 as α·dm/dt. Expanding the noise component ¿(t) to a first order in t, EQ. 15 becomes:

dP=g·dm/S+α·dm/dt+ε₀+ε₁·t. (EQ. 16)

EQ. 16 has four unknown parameters (ε₀, ε₁, dm and α) and can therefore be determined using four independent readings of sensor 442. Consider, for example, the following four sample readings P(t): M₀=P(t=t₀), M₁=P(t=t₀+dt), M₂=P(t=t₀+2dt), and M₃=P(t=t₀+3dt), where the jetting time dt start at t=t₀+τ, where τ is a jetting delay parameter. The values of dP_{f} and dP_{g} can be calculated using these sample readings according to the following relations:

dP_{f}=(M₁−M₀)+(M₃−M₀)−2(M₂−M₀) (EQ. 17)

dP_{g}=3(M₂−M₀)−2(M₃−M₀) (EQ. 18)

The value of the time delay parameter τ is optionally and preferably less than the jetting time dt and not less than the sampling time of the pressure. For example, τ can be the sampling time.

### Example 2

### Experimental

Following is a description of several experiments performed using the system illustrated in FIG. 4A. The printing head 16 was a 192-nozzle printing head of a J750™ three-dimensional printing system by Stratasys, Ltd., Israel. The sensor 442 was a MPXV7002DP sensor by NXP Semiconductors N.V., Eindhoven, Netherlands. The cross-sectional area of conduit 440 was S=65.7±2.8 cm².

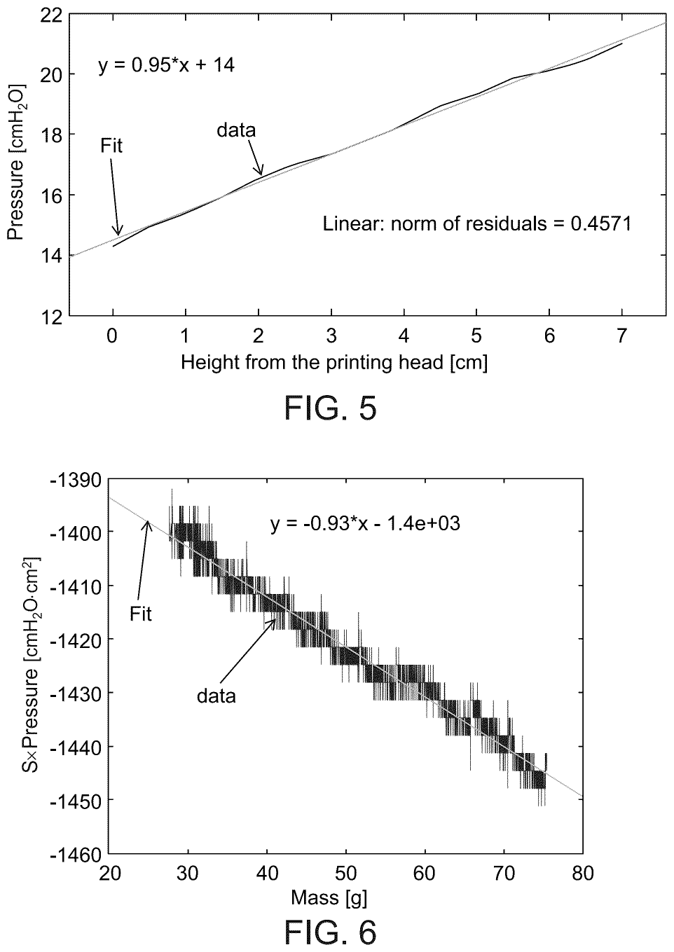

A first experiment was directed to ensure that the value of dP_{g}/dH is constant and equals the density ρ of the liquid material. FIG. 5 shows the pressure P_{g} in cm H₂O as a function of the height from the printing head in cm. The curved line represents the measured pressure values and the straight line is a linear fit to the measured pressure values. As shown the data correlates well with a straight line, indicating that dP_{g}/dH is approximately constant. The fitted value of the slope of the straight line is

$$\\ \frac{dP}{dH} = 0.95 \pm 0.0725 [ \frac{cm {H}_{2} O}{cm} ]$$

with confident interval of 95%. This result is consistent (within less than 10%) with the density ρ=1.0313 cmH₂O/cm.

Since dP_{g}/dH≈ρ, the value of SdP_{g}/dm, in absolute value, is approximately 1. In a second experiment, the jetted mass was measured by a balance placed below printing head during jetting. FIG. 6 shows the measured value of S·P_{g} as a function of the jetted mass in grams. As shown the data correlates well with a straight line, indicating that SdP_{g}/dm is approximately constant. The fitted value of the slope of the straight line is SdP_{g}/dm≈−0.93 consistent with unity and with the consistency level obtained for dP_{g}/dH.

A third experiment was directed to the calculation of the α ratio (see EQ. 6) using the measured pressure. In this experiment, N=192 nozzles of the printing head were operated to execute a jetting sequence of n_{f}=1,000,000 firing events at a dispensing frequency f=38 KHz (corresponding to a jetting time dt of n_{f}/f=26.3158 seconds), every 132 seconds. FIG. 7A shows the pressure P_{f} in cm H₂O as measured by sensor 442, as a function of the time in seconds. The jump in the pressure during jetting is denoted dP_{f} on FIG. 7A, and is mainly related to the flowrate. FIG. 7B shows a zoom-in along the ordinate of FIG. 7A. For clarity of presentation, the pressure during the jetting is not shown in FIG. 7B. The difference in the static pressure between successive jetting events is denoted dP_{g} on FIG. 7B.

The values of dP_{g} and dP_{f} as obtained from the measurements shown in FIGS. 7A and 7B are summarized in Table 1, below.

TABLE 1

| | |
|---|---|
| dPg | −0.1220 ± 0.0079 cmH₂O |
| dP_{f} | −3.0204 ± 0.0070 cmH₂O |

Multiplying the measured value of dP_{g} by the cross-sectional area S and dividing by the jetting time dt one obtains S·dP_{g}/dt=−0.3049±0.0234 g/s. Since SdPg/dm≈1, the obtained value for S·dPg/dt was also the value of the mass flow rate dm/dt. The a ratio dP_{f}/(dm/dt) was then calculated by dividing the measured value of dP_{g} by the mass flow. The obtained value was dP_{f}/(dm/dt)=9.9069±0.8718 cmH₂O·s/g. The α ratio was also used for calculating the mass m_{d} of a single drop. This was done according to the relation m_{d}=dPf/(α·f·N), resulting in a drop mass of m_{d}=41.75±3.62 ng. A fourth experiment was directed to determine the number of operative nozzles in the printing head. In this experiment, the printing head was operated to execute six jetting sequences, each including n_{f}=100,000 firing events at a dispensing frequency f=38 KHz (corresponding to a jetting time dt of n_{f}/f=2.63158 seconds) using a different number N of nozzles. The mass change per firing event was calculated as T_{f}·dm/dt, where T_{f} is the duration of a firing event defined as T_{f}=1/f, and dm/dt is the mass flow rate which was calculated using the relation dm/dt=dPf/α, where for the a ratio the value obtained from the data in the third experiment was used.

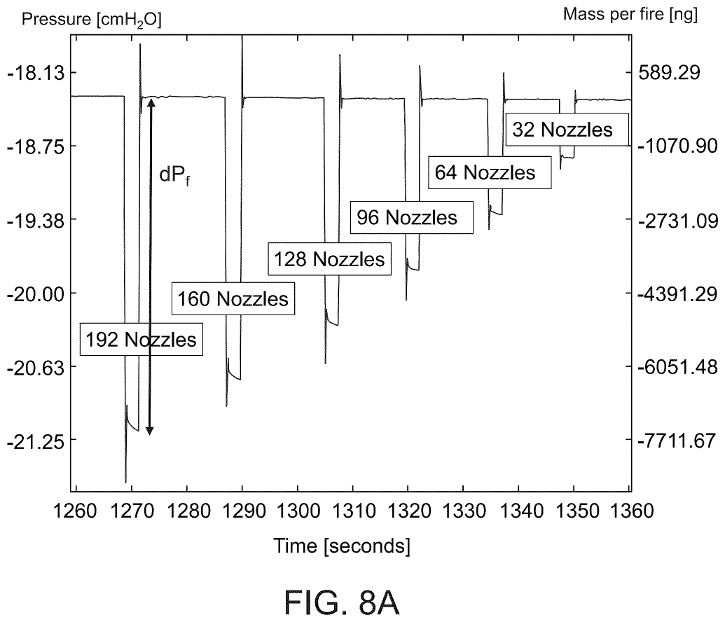

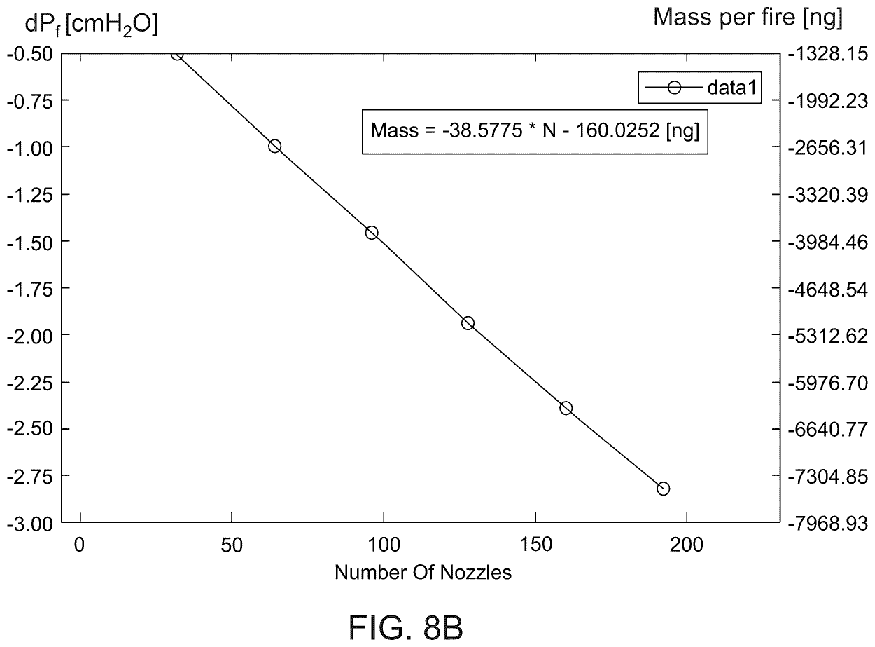

FIG. 8A shows the pressure measured by sensor 442 in cm H₂O (left ordinate) and the corresponding mass change per firing event in ng (right ordinate), as a function of the time in seconds. The jump in the pressure during jetting is denoted dP_{f} on FIG. 8A. Also shown in FIG. 8A, is the number N of operative nozzles in each jetting sequence. FIG. 8B shows the pressure jump dP_{f} of FIG. 8A in cm H₂O (left ordinate) and the corresponding mass change per firing event in ng (right ordinate), as a function of the number of operative nozzles. As shown, the mass per firing event changes approximately linearly with the number of operative nozzles. A linear fit to the six values on the right ordinate, provided a calculated slope of 38.577N±72.1575 [ng], demonstrating a detection resolution of 2 out of N defective nozzles.

A fifth experiment was directed to demonstrate adjustment of the voltage applied to the printing head based on the calculated average drop mass. In this experiment, the printing head was operated to execute a jetting sequence including n_{f}=100,000 firing events at a dispensing frequency f=38 KHz (corresponding to a jetting time dt of n_{f}/f=2.63158 seconds) every 13.1579 seconds, applying a different voltage to the printing head for each jetting sequence. The drop mass was calculated using the a ratio obtained from the data in the third experiment, according to the relation m_{d}=dP_{f}/(α·f·N).

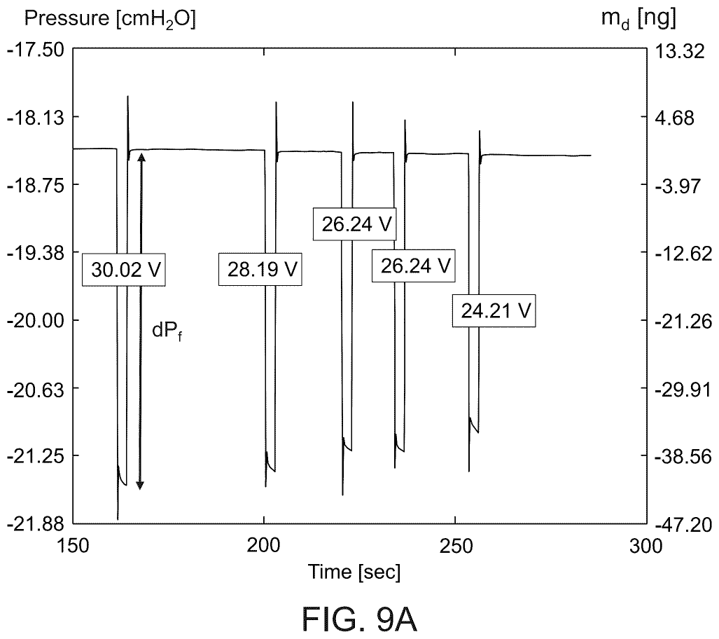

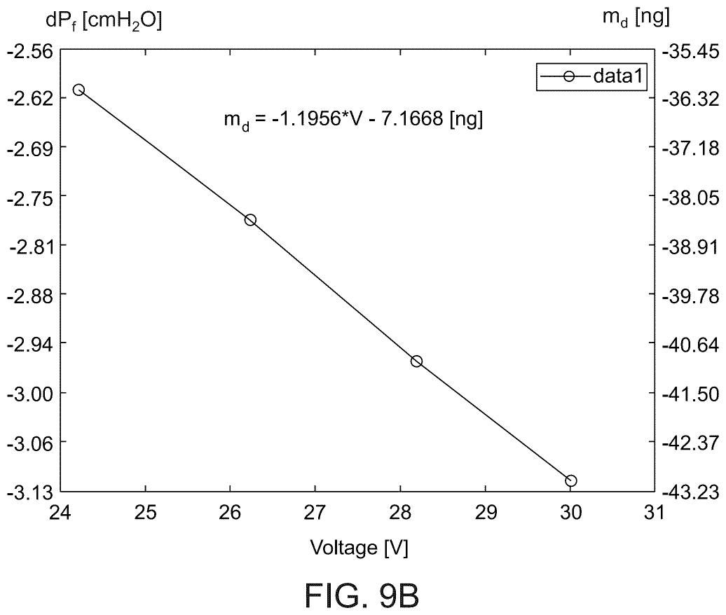

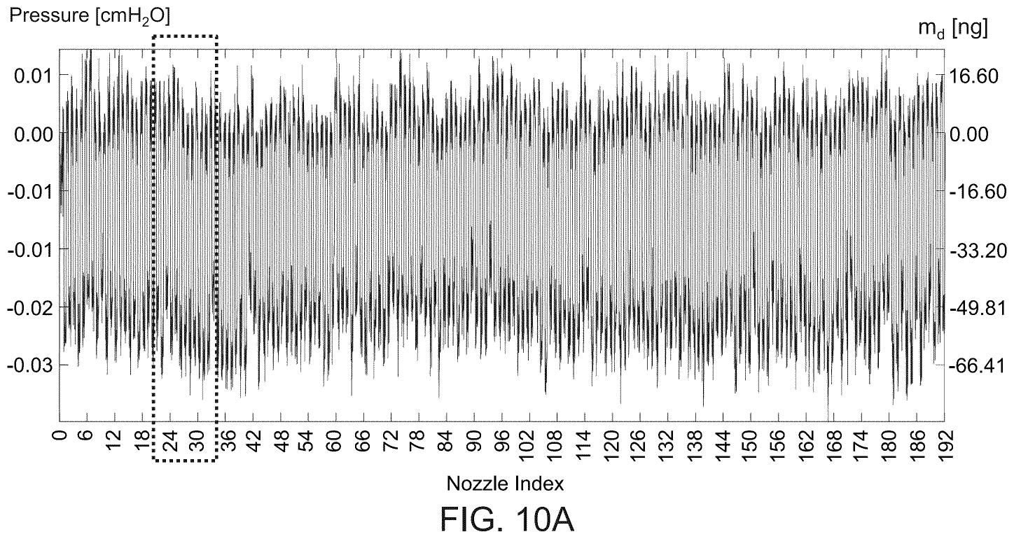

FIG. 9A shows the pressure measured by sensor 442 in cm H₂O (left ordinate) and the corresponding drop mass m_{d} in ng (right ordinate), as a function of the time in seconds. The jump in the pressure during jetting is denoted dP_{f} on FIG. 9A. Also shown in FIG. 9A is the voltage applied to the printing head for each jetting sequence. FIG. 9B shows the pressure jump dP_{f} of FIG. 9A in cm H₂O (left ordinate) and the corresponding drop mass m_{d} in ng (right ordinate), as a function of the applied voltage. As shown, the drop mass ma changes approximately linearly with the voltage applied to the printing head. A linear fit to the six values on the right ordinate, provided m_{d}=−1.1956*V−7.1668±0.1 [ng] demonstrating high calibration precision (about 0.4%) even at a relatively small number of firing events (100,000, in this experiment).

A sixth experiment was directed to demonstrate single nozzle inspection. In this experiment, the printing head was operated to execute 192 jetting sequences, each using a different single nozzle of the printing head and including n_{f}=100,000 firing events at a dispensing frequency f=38 KHZ (corresponding to a jetting time dt of n_{f}/f=2.63158 seconds). In other words, each of the nozzles of the printing head was used separately. The time period between successive sequences was 5 seconds. The drop mass was calculated using the α ratio obtained from the data in the third experiment, according to the relation m_{d}=dP_{f}/(α·f·N).

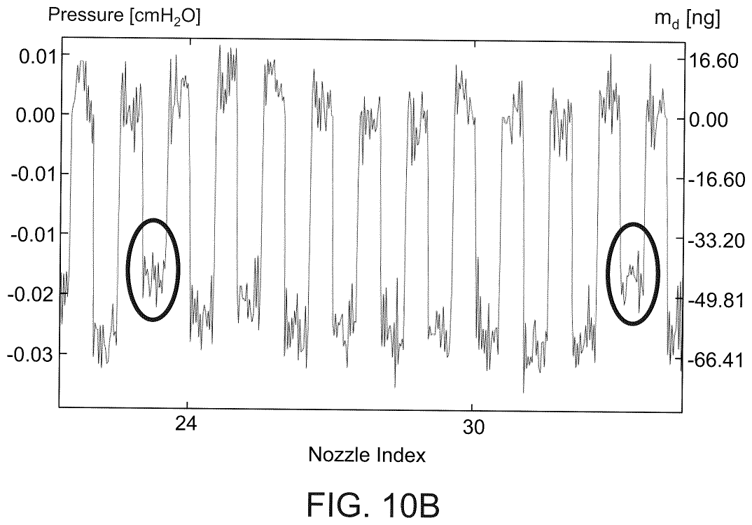

FIG. 10A shows the difference in cm H₂O between the pressure measured by sensor 442 with jetting and when no jetting was performed (left ordinate) and the corresponding drop mass ma in ng (right ordinate), as a function of the nozzle's index. The data in FIG. 10A are presented after applying a background reduction procedure using the MATLAB® software's code Background=(imopen (imclose (Data, ones (20,1)), ones (20, 1))). A zoom-in of the section of FIG. 10A marked by a dotted rectangle is shown in FIG. 10B. The data for the 23rd and the 33rd nozzles (marked by black ovals) show a drop mass value which is reduced compared to the other nozzles. These nozzles can therefore be identified as defective since they dispense droplets of smaller masses. In some embodiments of the invention, the measured pressure after jetting of a nozzle and/or the corresponding drop mass value are compared to one or more predetermined thresholds or values (e.g. pressure or drop mass following manufacturing or installation or calibration of the printhead in the printing system). In that way, for instance, at any time t, the nozzle (or a group of nozzles) may be checked and identified as active, partially defective, or inactive. Controller 420 can then use or transmit this information to improve the printing quality by compensating or avoiding the use of partially defective or inactive nozzle during printing or triggering a special event. In some embodiments of the invention, such a special event may be cleaning or purging of one or more individual nozzles, a whole nozzle array (i.e. channel), printhead or printing block at a cleaning or purging station, or issuing an alert message to the user informing that print head replacement is needed.

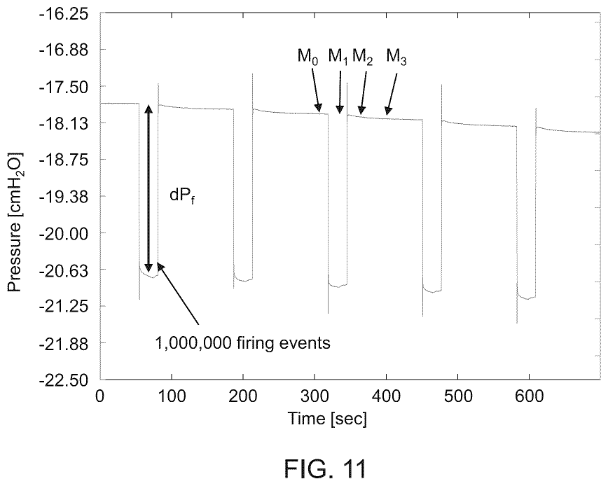

A seventh experiment was directed to demonstrate the ability to remove the noise component from the measurements using the procedure described above in connection with EQs. 15-18. In this experiment, N=192 nozzles of the printing head were operated to execute jetting sequence of n_{f}=1,000,000 firing events at a dispensing frequency f=38 KHz (corresponding to a jetting time dt of n_{f}/f=26.3158 seconds). FIG. 11 exemplifies measurement samplings over a graph of a pressure as a function of the time, according to some embodiments of the present invention. Shown are time points at which four sample measurements M₀ . . . M₃ can be obtained.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicants that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A printing system, comprising:
an inkjet printing head having a plurality of nozzles;
a container, containing a liquid material and being in fluid communication with said head by a conduit for feeding said head with said liquid material;
a pressure sensor configured to generate a signal indicative of a pressure at an outlet of said conduit; and
a controller, configured to control said head to dispense through said nozzles liquid material received via said conduit, and to calculate at least one jetting characteristic based on said pressure.

2. The system according to claim 1, wherein said at least one jetting characteristic comprises an average drop mass dispensed from said head.

3. The system according to claim 2, wherein said controller is configured to adjust a voltage applied to said head based on said calculated average drop mass.

4. The system according to claim 1, wherein said at least one jetting characteristic comprises a mass change per number of dispensing events from said nozzles.

5. The system according to claim 1, wherein said at least one jetting characteristic comprises a number of operative nozzles in said head.

6. The system according to claim 5, wherein said controller is configured to identify among said plurality of nozzles a subset of nozzles in which at least one nozzle is defective, based on said number of operative nozzles.

7. The system according to claim 5, wherein said controller is configured to individually identify a defective nozzle among said plurality of nozzles, based on said number of operative nozzles.

8. The system according to claim 1, wherein said at least one jetting characteristic comprises a mass flow rate through said nozzles.

9. The system according to claim 1, wherein said controller is configured to receive computer print data from an external source, and to calculate said at least one jetting characteristic while forming printed patterns according to said computer print data.

10. The system according to claim 9, wherein said controller is configured to execute a noise reduction procedure.

11. The system according to claim 1, wherein said head is at a higher level than said container.

12. The system according to claim 1, wherein said head is at a lower level than said container, wherein said container feeds the head via a sub-tank having an opening to the atmosphere and being connected to said head by said conduit.

13. The system according to claim 1, being a two-dimensional printing system.

14. The system according to claim 1, being a three-dimensional printing system.

15. A method of calculating a jetting characteristic of a printing system, the method comprising:
receiving from a pressure sensor a signal indicative of a pressure at an outlet of a conduit feeding a printing head with liquid material; and
calculating at least one jetting characteristic based on said pressure.

16. The method according to claim 15, wherein said at least one jetting characteristic comprises an average drop mass dispensed from said head.

17. The method according to claim 16, comprising adjusting a voltage applied to said head based on said calculated average drop mass.

18. The method according to claim 15, wherein said at least one jetting characteristic comprises a mass change per number of dispensing events from said nozzles.

19. The method according to claim 15, wherein said at least one jetting characteristic comprises a number of operative nozzles in said head.

20. The method according to claim 19, comprising identifying among said plurality of nozzles a subset of nozzles in which at least one nozzle is defective, based on said number of operative nozzles.

21. The method according to claim 19, comprising individually identifying a defective nozzle among said plurality of nozzles, based on said number of operative nozzles.

22. The method according to claim 15, wherein said at least one jetting characteristic comprises a mass flow rate through said nozzles.

23. The method according to claim 15, comprising receiving computer print data from an external source, and calculating said at least one jetting characteristic while forming printed patterns according to said computer print data.

24. The method according to claim 23, comprising executing a noise reduction procedure.

25. The method according to claim 15, wherein said printing system is a two-dimensional printing system.

26. The method according to claim 15, wherein said printing system is a three-dimensional printing system.
